(19) United States
(12) Patent Application Publication
(10) Pub. No.: US 2017/0134596 A1
(43) Pub. Date: May 11, 2017

(54) INFORMATION PROCESSING APPARATUS, INFORMATION PROCESSING METHOD AND NON-TRANSITORY COMPUTER READABLE MEDIUM

(71) Applicant: FUJI XEROX CO., LTD., Tokyo (JP)

(72) Inventors: Mitsuru SATO, Kanagawa (JP); Masaya KOJIMA, Kanagawa (JP); Hideo SASAGAWA, Kanagawa (JP); Kazuya IIMURA, Kanagawa (JP); Kiyoshi TAKAHASHI, Kanagawa (JP); Hiroyuki TOJO, Kanagawa (JP)

(73) Assignee: FUJI XEROX CO., LTD., Tokyo (JP)

(21) Appl. No.: 15/093,202

(22) Filed: Apr. 7, 2016

(30) Foreign Application Priority Data
Nov. 10, 2015 (JP) 2015-220051

(51) Int. Cl. H04N 1/00

(52) U.S. Cl. CPC H04N 1/00206; H04N 1/00244; H04N 1/00411; H04N 2201/0094; H04N 2201/006

(57) ABSTRACT

Provided is an information processing apparatus including a receiving unit that receives an operation for an operation target device, and an acquisition unit that acquires, through a near field radio communication, information on the operation target device, which is stored in the operation target device connected through the near field radio communication, during the operation, wherein the information on the operation target device is information that the operation target device acquires from an external device.

### CROSS-REFERENCE TO RELATED APPLICATIONS

This application is based on and claims priority under 35 USC 119 from Japanese Patent Application No. 2015-220051 filed Nov. 10, 2015.

### BACKGROUND

(i) Technical Field

The present invention relates to an information processing apparatus, an information processing method and a non-transitory computer readable medium.

(ii) Related Art

Some devices may acquire information from other apparatuses, using communication units in a wireless communication manner or a wired communication manner.

### SUMMARY

According to an aspect of the invention, there is provided

an information processing apparatus including:

a receiving unit that receives an operation for an

operation target device; and

an acquisition unit that acquires, through a near field radio communication, information on the operation target device, which is stored in the operation target device connected through the near field radio communication, during the operation,

wherein the information on the operation target device is information that the operation target device acquires from an external device.

### BRIEF DESCRIPTION OF THE DRAWINGS

Exemplary embodiments of the present invention will be described in detail based on the following figures, wherein:

FIG. 1 is a block diagram illustrating an image forming system according to an exemplary embodiment of the present invention;

FIG. 2 is a block diagram illustrating an image forming apparatus;

FIG. 3 is a block diagram illustrating a server;

FIG. 4 is a block diagram illustrating a terminal apparatus;

FIG. 5 is a diagram illustrating a menu screen;

FIG. 6 is a diagram illustrating a help screen; and

FIG. 7 is a sequence diagram illustrating an example of a process by the image forming system according to the exemplary embodiment.

### DETAILED DESCRIPTION

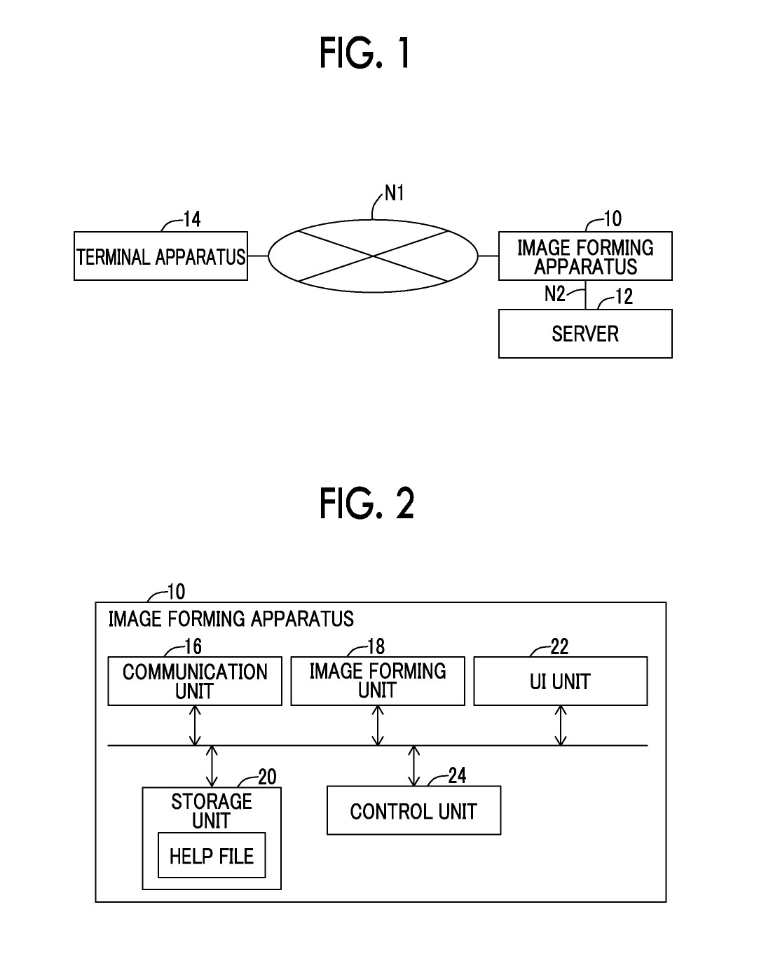

FIG. 1 illustrates an example of an image forming system as an information processing system according to an exemplary embodiment of the present invention. The image forming system includes, for example, an image forming apparatus 10, a server 12, and a terminal apparatus 14.

The image forming apparatus 10 and the terminal apparatus 14 are connected to, for example, a communication path N1 such as a local area network (LAN). The communication path N1 is formed, for example, through the near field radio communication such as Wi-Fi. The image forming apparatus 10 and the server are connected to a communication path N2 formed of a dedicated line. The communication path N2 may be formed of a virtual private network (VPN).

The image forming apparatus 10 is, for example, an apparatus provided with at least one function out of a copy function, a print function, a scan function, and a facsimile function. Furthermore, the image forming apparatus 10 is provided with, for example, a near field radio communication function such as Wi-Fi, and a function of performing communication by being connected to a dedicated line, and includes a function of transmitting and receiving data to and from other apparatuses. Of course, the image forming apparatus 10 may include a function of being connected to a communication path such as the Internet.

The server 12 as an external device stores data such as software to be used in the image forming apparatus 10. Further, the server 12 has, for example, a function of performing communication by being connected to a dedicated line, and includes a function of transmitting and receiving data to and from other apparatuses. Of course, the server 12 may include a function of being connected to a communication path such as the Internet. For example, the software stored in the server 12 is transmitted to the image forming apparatus 10 through the communication path N2. Further, the server 12 stores a help file regarding a process (function) executed by the image forming apparatus 10, and the help file is transmitted to the image forming apparatus 10 through the communication path N2. The help file is operation explanatory information indicating the explanation of the operation for a process.

The terminal apparatus 14 as the information processing apparatus is an apparatus such as a personal computer (PC), a tablet PC, a smart phone, and a mobile phone. The terminal apparatus 14 is used by a user, for example, at the time of execution of the process by the image forming apparatus 10. The terminal apparatus 14 has, for example, the near field radio communication function such as Wi-Fi, and a function of transmitting and receiving data to and from other apparatuses. Of course, the terminal apparatus 14 may be provided with a function of being connected to the communication path such as the Internet.

Hereinafter, the details of the configuration of the image forming apparatus 10 will be described with reference to FIG. 2. FIG. 2 illustrates the configuration of the image forming apparatus 10.

A communication unit 16 is a communication interface, and is provided with a function of transmitting data to other apparatuses, and a function of receiving data from other apparatuses, through communication paths N1, N2. The communication unit 16 has, for example, the near field radio communication function such as Wi-Fi, and transmits and receives data through the communication path N1 using the function. In addition, the communication unit 16 transmits and receives data to and from the server 12 through the communication path N2 formed of a dedicated line or the like. Of course, the communication unit 16 may be provided with a function of being connected to the communication path such as the Internet. In this exemplary embodiment, the communication unit 16 receives the software and the help file, transmitted from the server 12. In addition, the help file and the image data and the like are transmitted to the terminal apparatus 14 by the communication unit 16, and the communication unit 16 receives the image data, the control data, and the like, transmitted from the terminal apparatus 14.

An image forming unit 18 is provided with a function of performing a process about image formation. For example, a copy process, a print process, a scan process, a facsimile process, and the like are performed by the image forming unit 18. Original documents are copied in the copy process. An image is printed on a recording medium such as paper in the print process. Image data is generated by an original document being read in the scan process. Image data is transmitted or received by a facsimile in the facsimile process.

In this exemplary embodiment, the process about image formation is performed using the terminal apparatus 14. For example, image data to be printed is transmitted from the terminal apparatus 14 to the image forming apparatus 10, through the communication path N1 by Wi-Fi communication, and an image based on the image data is printed on a recording medium by the image forming unit 18. Further, image data generated through the scan process by the image forming unit 18 is transmitted from the image forming apparatus 10 to the terminal apparatus 14, through the communication path N1 by Wi-Fi communication. For example, such a function is realized, by installing application software for executing the process about image formation in the terminal apparatus 14.

A storage unit 20 is a storage device such as a hard disk. The storage unit 20 stores, for example, data to be printed, data generated through the scan process, and the like. Further, the storage unit 20 stores a help file indicating the explanation of the operation of the image forming apparatus 10. This help file is data that is transmitted from the server 12. For example, a help file of each individual function provided in the image forming apparatus 10, in other words, a help file for each individual process that is performed by the image forming apparatus 10 is stored in the storage unit 20. Specifically, a help file about the print process, a help file about the scan process (a scan transfer process), a help file about Wi-Fi connection configuration, and the like are stored in the storage unit 20. The help file about the print process is information indicating the explanation of an operation at the time of performing the print process by using the terminal apparatus 14. The help file about the scan process is information indicating the explanation of an operation at the time of performing the scan process by using the terminal apparatus 14. The help file about the Wi-Fi configuration connection is information indicating the explanation of an operation at the time of performing Wi-Fi connection by using the terminal apparatus 14. Of course, one help file may indicate an explanation regarding plural functions (processes). As will be described later, the help file of an acquisition target is transmitted from the image forming apparatus 10 to the terminal apparatus 14, in response to an acquisition request from the terminal apparatus 14. This process will be described in detail later.

A UI unit 22 is a user interface, and includes a display unit and an operation unit. The display unit is a display device such as a liquid crystal display, and the operation unit is an input device such as a control panel or a touch panel.

A control unit 24 is provided with a function of controlling the operation of each unit of the image forming apparatus 10.

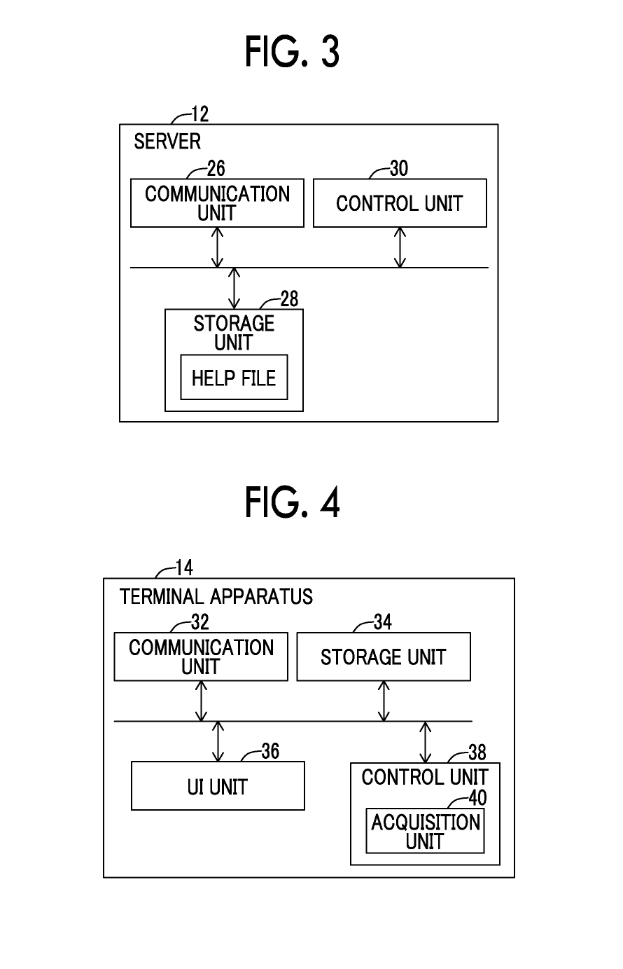

Hereinafter, the configuration of the server 12 will be described in detail, with reference to FIG. 3. FIG. 3 illustrates the configuration of the server 12.

A communication unit 26 is a communication interface, and is provided with a function of transmitting data to other apparatuses and a function of receiving data from other apparatuses, for example, through the communication path N2 formed of a dedicated line. Of course, the communication unit 26 may be provided with a function of being connected to the communication path such as the Internet. In this exemplary embodiment, information indicating an acquisition request for software or a help file is transmitted by the image forming apparatus 10, and the information is received by the communication unit 26. In addition, the software or the help file of an acquisition target is transmitted to the image forming apparatus 10 by the communication unit 26.

A storage unit 28 is a storage device such as a hard disk. The storage unit 28 stores, for example, data such as software that is used by the image forming apparatus 10. In addition, the storage unit 28 stores help files for the image forming apparatus 10. For example, a help file corresponding to the type, the model number, the version, or the like of the image forming apparatus 10 is generated in advance and stored in the storage unit 28. More specifically, a help file of each individual function (each process) provided in the image forming apparatus 10 is generated in advance and stored in the storage unit 28. Of course, one help file may include information indicating the explanation of the operations for plural functions.

A control unit 30 is provided with a function of controlling the operation of each unit of the server 12. The control unit 30 receives, for example, an acquisition request for the software and the help file from the image forming apparatus 10, and acquires the software and the help file of an acquisition target from the storage unit 28. The software and the help file are transmitted to the image forming apparatus 10 through the communication path N2.

Hereinafter, the configuration of the terminal apparatus 14 will be described in detail with reference to FIG. 4. FIG. 4 illustrates the configuration of the terminal apparatus 14.

A communication unit 32 is a communication interface provided with the near field radio communication function such as Wi-Fi, and is provided with a function of transmitting data to other apparatuses and a function of receiving data from other apparatuses, through the communication path N1. Of course, the communication unit 32 may be provided with a function of being connected to the communication path such as the Internet. In this exemplary embodiment, image data, control data, and the like are transmitted to the image forming apparatus 10 by the communication unit 32, and the communication unit 32 receives the image data and the help file and the like, transmitted from the image forming apparatus 10.

A storage unit 34 is a storage device such as a hard disk. The storage unit 34 stores, for example, image data, software, and the like.

A UI unit 36 is a user interface, and includes a display unit and an operation unit. The display unit is, for example, a display device such as a liquid crystal display. The operation unit is, for example, an input device such as a touch panel or a keyboard.

A control unit 38 is provided with a function of controlling the operation of each unit of the terminal apparatus 14. In addition, the control unit 38 includes the acquisition unit 40. The acquisition unit 40 is provided with a function of transmitting information indicating the acquisition request for the help file to the image forming apparatus 10 through the communication path N1, and acquiring the help file from the image forming apparatus 10 through the communication path N1.

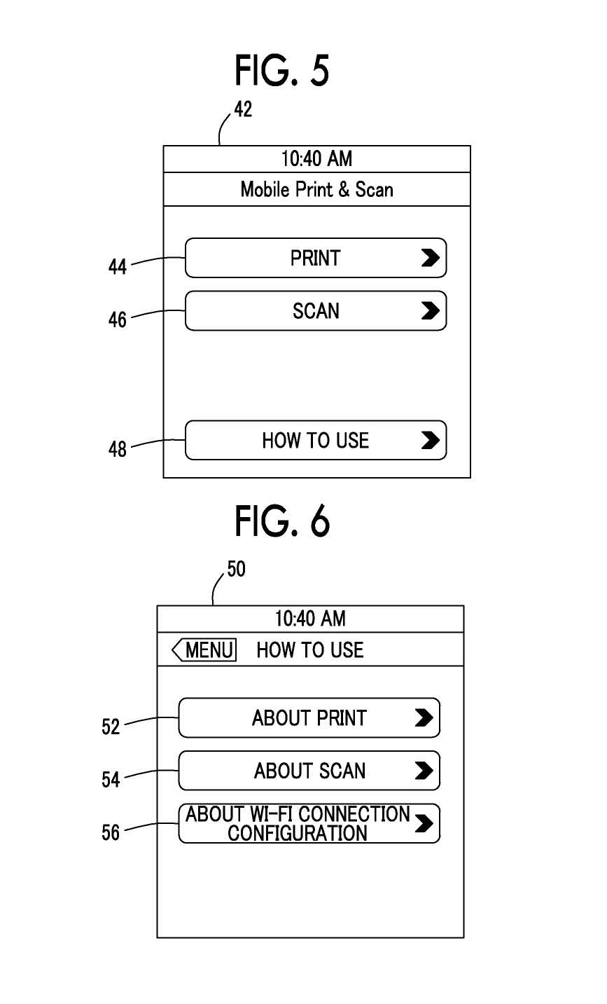

Hereinafter, the image forming system according to this exemplary embodiment will be described in more detail. FIG. 5 illustrates an example of a menu screen displayed on the terminal apparatus 14. For example, if a dedicated application program that is installed in the terminal apparatus 14 is started, the control unit 38 of the terminal apparatus 14 displays a menu screen 42 on the UI unit 36 of the terminal apparatus 14. In the example illustrated in 5, the execution of the print process and the scan process is adapted to be specified on the menu screen 42. As an example, a print button 44, a scan button 46, and a help button 48 are displayed on the menu screen 42. If the print button 44 is pressed by the user, the execution of the print process is instructed. In this case, image data to be printed that is selected by the user is transmitted to the image forming apparatus 10 through the communication path N1. In the image forming apparatus 10, an image based on image data to be printed is printed on the paper by the image forming unit 18. If the scan button 46 is pressed by the user, the execution of the scan process (scan transfer process) is instructed. In this case, the scan process is executed by the image forming unit 18 and the image data generated through this scan process is transmitted from the image forming apparatus 10 to the terminal apparatus 14 through the communication path N1. If the help button 48 is pressed by the user, the help screen is displayed on the UI unit 36. For example, the screen changes from the menu screen to the help screen, and a help file indicating the explanation of the operation is displayed on the UI unit 36. In this exemplary embodiment, the help file is transmitted from the image forming apparatus 10 to the terminal apparatus 14, and is displayed on the UI unit 36.

FIG. 6 illustrates an example of the help screen displayed on the terminal apparatus 14. A print help button 52, a scan help button 54, and a Wi-Fi connection help button 56 are displayed on a help screen 50, as an example. If the print help button 52 is pressed by the user, a help file indicating the explanation of the operation at the time of performing a print process by using the terminal apparatus 14 is displayed on the UI unit 36 of the terminal apparatus 14. Specifically, an explanation about the selection of the image data to be printed, an explanation about the transmission of the image data to the image forming apparatus 10, an explanation about the configuration of printing conditions, and the like are displayed on the UI unit 36. If the scan help button 54 is pressed by the user, a help file indicating the explanation of the operation at the time of performing the scan process by using the terminal apparatus 14 is displayed on the UI unit 36. Specifically, an explanation about the configuration of scan conditions, an explanation about the transmission of image data from the image forming apparatus 10 to the terminal apparatus 14, and the like are displayed on the UI unit 36. If the Wi-Fi connection help button 56 is pressed by the user, a help file indicating the explanation of the operation at the time of connecting to the image forming apparatus 10 by using Wi-Fi is displayed on the UI unit 36. In this exemplary embodiment, a help file about the print process, a help file about the scan process, and a help file about Wi-Fi connection are transmitted from the image forming apparatus 10 to the terminal apparatus 14 and are displayed on the UI unit 36. Incidentally, the help file illustrated in FIG. 6 is only an example, and a help file about other function (process) may be displayed.

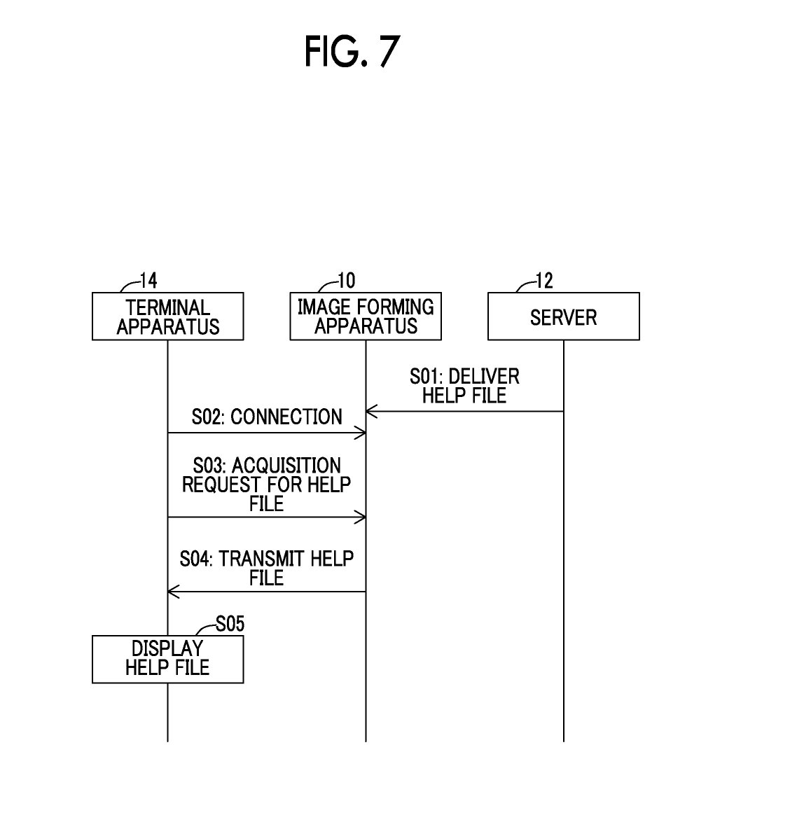

Hereinafter, a process by the image forming system according to the exemplary embodiment will be described with reference to FIG. 7. FIG. 7 is a sequence diagram illustrating the process.

First, a help file is delivered from the server 12 to the image forming apparatus 10 through the communication path N2 formed of a dedicated line (S01). The help file is information indicating the explanation of an operation of the image forming apparatus 10. In addition, the process of step S01 is performed in advance. Further, the process of step S01 may be performed on a regular basis. In the process of step S01, software that is used by the image forming apparatus 10 may be delivered from the server 12 to the image forming apparatus 10.

Next, if the user instructs the connection to the image forming apparatus 10 which is the operation target device, by operating the terminal apparatus 14, the terminal apparatus 14 is connected to the communication path N1 using Wi-Fi. Thus, the terminal apparatus 14 and the image forming apparatus 10 are connected to each other through the communication path N1 (S02). In this exemplary embodiment, the operation target device is not limited to a device that is actually operated by the user (for example, a device that is actually operated by the user through the terminal apparatus 14), and may be a device that may be operated by the user (for example, a device that may be operated by the user through the terminal apparatus 14). The device that may be operated by the user is, for example, the image forming apparatus 10 that is in a state capable of being connected to the terminal apparatus 14 through Wi-Fi communication (the communication path N1), or the image forming apparatus 10 that is connected to the terminal apparatus 14 through Wi-Fi communication. Of course, the operation target device may be a device that is actually operated by the user.

Next, if the user instructs the acquisition of a help file, by operating the terminal apparatus 14, the terminal apparatus 14 transmits information indicating the acquisition request for the help file to the image forming apparatus 10, through the communication path N1 (S03).

When receiving the acquisition request for the help file from the terminal apparatus 14, the control unit 24 of the image forming apparatus 10 acquires the help file from the storage unit 20. The help file is transmitted from the image forming apparatus 10 to the terminal apparatus 14 through the communication path N1 (S04).

In the terminal apparatus 14, the help file that has been transmitted from the image forming apparatus 10 is displayed on the UI unit 36 (S05).

As described above, according to this exemplary embodiment, the help file for the image forming apparatus 10 is transmitted from the image forming apparatus 10 to be operated, to the terminal apparatus 14. Thus, in the terminal apparatus 14, the help file for the image forming apparatus 10 is acquired, without direct connection to the server 12 which is separate from the image forming apparatus 10. As compared with the case of acquiring the help files for a multiple types of image forming apparatuses 10, the help file for the image forming apparatus 10 to be operated is acquired with a smaller data amount.

In addition, since the help file may be acquired from the image forming apparatus 10 when the image forming apparatus 10 is in use, or is in a state that may be used, it is not necessary to store the help file in advance in the terminal apparatus 14. When the help file is stored in advance in the terminal apparatus 14, even when the image forming apparatus 10 is not in use, or is not in a state that may be used, the storage area of the terminal apparatus 14 is normally consumed. According to this exemplary embodiment, such wasteful consumption is avoided.

Further, according to this exemplary embodiment, the image forming apparatus 10 may store the help file for the image forming apparatus 10, without storing the help file for other apparatuses. Therefore, as compared with the case of storing the help file for other apparatuses, the capacity of data to be stored is reduced.

In the process of step S01, a help file corresponding to the type, the model number, and the version of the image forming apparatus 10 may be delivered from the server 12 to the image forming apparatus 10. For example, in the image forming apparatus 10, the communication unit 16 transmits information indicating the type, the model number, and the version of the image forming apparatus 10 to the server 12, under the control of the control unit 24. The transmission of information may be performed periodically, or may be performed in response to an instruction by an administrator or the like. In the server 12, the control unit 30 acquires the help file corresponding to the type, the model number, and the version thereof from the storage unit 28, and the communication unit 26 transmits the help file to the image forming apparatus 10. The storage unit 20 of the image forming apparatus 10 stores the help file that is transmitted from the server 12. For example, the help file of each individual function (each process) provided in the image forming apparatus 10 is delivered from the server 12 to the image forming apparatus 10, and is stored in the storage unit 20. Of course, the help file indicating the explanation of the operation of plural functions may be delivered from the server 12 to the image forming apparatus 10. Since the help file corresponding to the type, the model number, and the version is delivered, when a new function is added to the image forming apparatus 10 or the like, the help file corresponding thereto is delivered to the image forming apparatus 10. Thus, even when the operating method of the image forming apparatus 10 is changed, a help file corresponding to the change is stored in the image forming apparatus 10, and the help file corresponding to the change is provided to the terminal apparatus 14. For example, the help file corresponding to the new function is displayed on the terminal apparatus 14. If the help file is stored in advance in the terminal apparatus 14, without being acquired from the image forming apparatus 10, each time the operating method is changed, in other words, each time the help file is changed, it may be necessary for the user to perform the update of the help file in the manual operation. In contrast, according to this exemplary embodiment, since the help file corresponding to the change of the operating method is transmitted to the terminal apparatus 14, by being connected to the image forming apparatus 10, the above-described operation is not needed. Further, according to this exemplary embodiment, the model selection by the user, and the installation operation by the user of the help file corresponding to the model are not required.

In this exemplary embodiment, all help files for the image forming apparatus 10 may collectively be transmitted from the image forming apparatus 10 to the terminal apparatus 14, or a help file of each process (each function) may be individually transmitted.

For example, in the process of step S03, the terminal apparatus 14 may make the acquisition request for the help file corresponding to the operation for the image forming apparatus (help file about the process in operation) to the image forming apparatus 10. Specifically, when the user instructs the acquisition of the help file during the operation of a printing process in the terminal apparatus 14, the terminal apparatus 14 makes a request for the acquisition of a help file about the printing process to the image forming apparatus 10. Similarly, when the user instructs the acquisition of the help file during the operation of a scan transfer process in the terminal apparatus 14, the terminal apparatus 14 makes a request for the acquisition of a help file about the scan transfer process to the image forming apparatus 10. For example, as illustrated in FIG. 6, an operation screen is displayed on the terminal apparatus 14, and a help button is displayed on the operation screen. If the user presses the help button, the acquisition request for the help file about the process in operation is performed. When receiving the acquisition request for the help file about the process in operation from the terminal apparatus 14, the control unit 24 of the image forming apparatus 10 acquires the help file from the storage unit 20. The help file is transmitted from the image forming apparatus 10 to the terminal apparatus 14, and is displayed on the UI unit 36 of the terminal apparatus 14. For example, when the acquisition request for the help file about the printing process is performed, the help file about the printing process is transmitted from the image forming apparatus 10 to the terminal apparatus 14, and is displayed on the UI unit 36 of the terminal apparatus 14. In this way, the help file about the process in operation is transmitted from the image forming apparatus 10 to the terminal apparatus 14, and displayed. Thus, as compared to the case of acquiring information including the help file about the processes other than the processes to be operated (for example, the processes that are not operated), the help file is acquired with a smaller data amount.

In addition, the image forming apparatus 10 may transmit the help file about the process (function) being executed to the terminal apparatus 14. The process being executed is specified according to the following sequence. The image forming apparatus 10 and the terminal apparatus 14 communicate with each other, for example, by writing a command to a common memory. The memory may be provided in the image forming apparatus 10, or may be provided in other apparatuses. The image forming apparatus 10 initializes the memory, the terminal apparatus 14 writes the connection request information in the memory, and the image forming apparatus 10 writes the connection result information to the memory. For example, during the scan transfer process, information indicating the download status of data (status of the download from the image forming apparatus 10 to the terminal apparatus 14) is written to the memory. In addition, during the print process, information indicating the upload status of data (the upload status from the terminal apparatus 14 to the image forming apparatus 10) is written to the memory. Therefore, the process which is currently being executed is specified based on the information written to the memory. The control unit 24 of the image forming apparatus 10 specifies the process which is currently being executed, by referring to the memory, and acquires the help file about the process from the storage unit 20. The help file is transmitted from the image forming apparatus 10 to the terminal apparatus 14, and is displayed on the UI unit 36 of the terminal apparatus 14. Accordingly, as compared with the case of acquiring the information including the help file about the process that is not being executed, the help file is acquired with a smaller data amount.

In the present exemplary embodiment, the image forming apparatus 10 and the server 12 are connected through the communication path N2 formed of a dedicated line, and the terminal apparatus 14 and the server 12 are not directly connected. Therefore, as compared with the case where the terminal apparatus 14 and the server 12 are directly connected, security for the server 12 is improved.

Incidentally, when the connection between the terminal apparatus 14 and the communication path N1 is disconnected, the control unit 38 of the terminal apparatus 14 may delete the help file from the terminal apparatus 14. When the terminal apparatus 14 is not connected to the communication path N1, the image forming apparatus 10 is not in a state of being able to be used through the terminal apparatus 14. In this case, if the help file is stored in the terminal apparatus 14, even though the image forming apparatus 10 is not in a state of being able to be used through the terminal apparatus 14, the storage area of the terminal apparatus 14 is utilized unnecessarily. In order to cope with this, the unnecessary utilization is avoided, by removing the help file from the terminal apparatus 14.

In the Wi-Fi communication, in general, a service set identifier (SSID) is used as an identifier of the access point. For example, in the case where the SSID is assigned to each individual image forming apparatus 10, when plural image forming apparatuses 10 are present within the access range of the terminal apparatus 14, plural SSIDs are detected by the terminal apparatus 14. Further, other SSID of Wi-Fi communication which is used by an apparatus other than the image forming apparatus 10 maybe detected by the terminal apparatus 14. In this way, when plural SSIDs are detected by the terminal apparatus 14, in this exemplary embodiment, the image forming apparatus 10 to be connected is specified based on the SSID, and the help file is transmitted from the image forming apparatus 10 to the terminal apparatus 14. Hereinafter, this process will be described in detail.

First, the control unit 24 of the image forming apparatus 10 writes information indicating a service (for example, a print process, a scan transfer process, or the like) that is provided by the image forming apparatus 10, to a storage area in the storage unit 20 for which an access by the terminal apparatus 14 is allowed. Incidentally, information indicating a service may be written to the common memory for which an access by the image forming apparatus 10 and the terminal apparatus 14 is allowed. In this case, the common memory is provided for each image forming apparatus 10, and each image forming apparatus 10 writes the information to the common memory corresponding to the image forming apparatus 10. The control unit 38 of the terminal apparatus 14 accesses the access point with a certain SSID. Accordingly, the image forming apparatus 10 to which the SSID is assigned and the terminal apparatus 14 are connected. The control unit 38 of the terminal apparatus 14 determines whether or not the service provided by the image forming apparatus 10 is the same as the service that is used by the terminal apparatus 14, based on the information stored in the storage unit 20 (information indicating the service provided by the image forming apparatus 10) by referring to the storage unit 20 of the image forming apparatus 10. When both services are the same, the control unit 38 of the terminal apparatus 14 makes an acquisition request for the help file to the image forming apparatus 10, and acquires the help file from the image forming apparatus 10. Meanwhile, when both services are different, the control unit 38 of the terminal apparatus 14 accesses the access point with the other SSID, and determines whether or not both service are the same by referring to the storage unit 20 of the image forming apparatus 10 to which the SSID is assigned.

When both services are the same, the help file about the service used by the terminal apparatus 14 is stored in the image forming apparatus 10 of the connection destination. Therefore, the terminal apparatus 14 acquires the help file from the image forming apparatus 10. Meanwhile, when both services are different, the help file about the service used by the terminal apparatus 14 is not stored in the image forming apparatus 10 of the connection destination. Therefore, the terminal apparatus 14 accesses the access point having a different SSID, and searches for the image forming apparatus 10 that provides a service that is used by the terminal apparatus 14. When the image forming apparatus 10 that provides a service used by the terminal apparatus 14 is detected through searching, in other words, when both services are the same, the terminal apparatus 14 acquires the help file from the image forming apparatus 10. Accordingly, the help file about the service used by the terminal apparatus 14 is acquired. Through this process, even when there are plural image forming apparatuses 10 that are communicable by the terminal apparatus 14 through Wi-Fi, the help file about the service used by the terminal apparatus 14 is acquired.

As another example, the terminal apparatus 14 may acquire the SSID of the connection destination, through non-contact communication such as the near field radio communication (NFC). For example, a transceiver is provided in the image forming apparatus 10 according to the NFC standard. The SSID that is assigned to the image forming apparatus 10 is transmitted from the image forming apparatus 10 to the terminal apparatus 14 by placing the terminal apparatus 14 provided with a communication function of the NFC standard, over the transceiver. The terminal apparatus 14 accesses the access point having the SSID. Thus, the terminal apparatus 14 and the image forming apparatus 10 are connected.

As another example, a list of SSIDs may be displayed on the UI unit 36 of the terminal apparatus 14. For example, a list of SSIDs of the access points that are connectable by the terminal apparatus 14 through Wi-Fi communication is displayed on the UI unit 36. If the SSID is specified in the list by the user, the terminal apparatus 14 accesses the access point having the SSID specified by the user. Thus, the terminal apparatus 14 and the specific image forming apparatus 10 are connected.

In this exemplary embodiment, when plural terminal apparatuses 14 that are connectable to the image forming apparatus 10 are present, the terminal apparatus 14 that the image forming apparatus 10 intends to communicate with is specified through the following process. First, connection information is transmitted to the image forming apparatus 10 of the connection destination from the terminal apparatus 14. For example, the connection information and identification information (for example, an IP address, a MAC address, and the like) of the terminal apparatus 14 are transmitted to the image forming apparatus 10 from the terminal apparatus 14, and the connection information and the identification information are associated with each other and stored in the storage unit of the image forming apparatus 10. The connection information may be, for example, a numerical value of a multi-digit (connection number), a preset value, or a value that is randomly generated. If the user inputs the connection information by using the UI unit 22, in the image forming apparatus 10 of the connection destination, the control unit 24 of the image forming apparatus 10 compares the connection information that is stored in the storage unit 20 with the connection information that is input by the user. When both pieces of connection information match, the control unit 24 of the image forming apparatus 10 transmits a help file to the terminal apparatus 14 that has transmitted the connection information, by referring to the identification information associated with the connection information. Thus, even when there are plural terminal apparatuses 14, the terminal apparatus 14 of the transmission destination of the help file is specified. When both pieces of connection information do not match, the verification fails, and the help file is not transmitted to the terminal apparatus 14.

As another example, the help file may be transmitted to a specific terminal apparatus 14 by encrypting the information that is transmitted and received between the terminal apparatus 14 and the image forming apparatus 10.

As another example, the help file may be transmitted to a specific terminal apparatus 14, by using the identification information (for example, a MAC address) for identifying the terminal apparatus 14. In this case, the terminal apparatus 14 transmits the identification information (for example, a MAC address) for identifying the terminal apparatus 14, to the image forming apparatus 10. The identification information is stored in the storage unit 20 of the image forming apparatus 10. At the time of the acquisition request for the help file, the terminal apparatus 14 transmits the identification information of the terminal apparatus 14, to the image forming apparatus 10. When the identification information is stored in the image forming apparatus 10, the image forming apparatus 10 transmits a help file to the terminal apparatus 14. When the identification information is not stored in the image forming apparatus 10, the image forming apparatus 10 does not transmit the help file to the terminal apparatus 14.

In addition, in the exemplary embodiment, information depending on the situation of the image forming apparatus 10 may be displayed on the terminal apparatus 14. For example, when the image forming apparatus 10 is in failure, error information is transmitted from the image forming apparatus 10 to the terminal apparatus 14 connected to the communication path N1, and the error information is displayed on the UI unit 36 of the terminal apparatus 14. Further, when consumables provided in the image forming apparatus 10 are used up, error information is transmitted from the image forming apparatus 10 to the terminal apparatus 14 connected to the communication path N1, and the error information is displayed on the UI unit 36 of the terminal apparatus 14. In this case, the error information may be displayed on the UI unit 22 of the image forming apparatus 10.

The image forming apparatus 10, the server 12, and the terminal apparatus 14, which are described above, are respectively realized by cooperation of hardware resources and software as an example. Specifically, the image forming apparatus 10, the server 12, and the terminal apparatus 14 are respectively provided with a processor such as a CPU which is not illustrated. The functions of the respective units of the image forming apparatus 10, the server 12, and the terminal apparatus 14 are implemented, by the processor reading and executing the program stored in the storage device which is not illustrated. The above program is stored in the storage device through a recording medium such as a CD or DVD, or through a communication path such as a network. Alternatively, the respective units of the image forming apparatus 10, the server 12, and the terminal apparatus 14 may be implemented, for example, by using hardware resources such as a processor or an electronic circuit. In the implementation, a device such as a memory may be used. As another example, each unit may be realized by a digital signal processor (DSP), a field programmable gate array (FPGA), or the like.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. An information processing apparatus comprising:
a receiver that receives an operation for an operation target device; and
a transceiver that acquires, through a near field radio communication, information on the operation target device, which is stored in the operation target device connected through the near field radio communication, during the operation,
wherein the information on the operation target device is information: (1) that the operation target device acquires from an external device, and (2) that indicates an explanation of the operation.

2. (canceled)

3. The information processing apparatus according to claim 1,
wherein when the information indicating the explanation of the operation is not acquired from the operation target device, the transceiver acquires the information indicating the explanation of the operation through the near field radio communication from an operation target device other than the operation target device.

4. The information processing apparatus according to claim 1, further comprising:
a transmitter that transmits connection information to the operation target device through the near field radio communication,
wherein when information corresponding to the connection information is input to the operation target device, the information on the operation target device is transmitted from the operation target device to the information processing apparatus through the near field radio communication, and the transceiver acquires the information.

5. (canceled)

6. The information processing apparatus according to claim 3, further comprising:
a transmitter that transmits connection information to the operation target device through the near field radio communication,
wherein when information corresponding to the connection information is input to the operation target device, the information on the operation target device is transmitted from the operation target device to the information processing apparatus through the near field radio communication, and the transceiver acquires the information.

7. The information processing apparatus according to claim 1, further comprising:
an operation information transmitter that transmits the information on an operation to the operation target device through the near field radio communication,
wherein the transceiver acquires the information on the operation target device through the near field radio communication.

8. (canceled)

9. The information processing apparatus according to claim 7,
wherein, when there are a plurality of operation target devices which are in communication through the near field radio communication, information on an operation target device is acquired from an operation target device that provides a same service as a service that is provided by an operation target device to which the operation information transmitter has transmitted the information.

10. (canceled)

11. An information processing method comprising:
receiving an operation for an operation target device; and
acquiring, through a near field radio communication, information on the operation target device, which is stored in the operation target device connected through the near field radio communication, during the operation,
wherein the information on the operation target device is information: (1) that the operation target device acquires from an external device, and (2) indicates an explanation of the operation.

12. A non-transitory computer readable medium storing a program causing a computer to execute information processing, the information processing comprising:
receiving an operation for an operation target device; and
acquiring, through a near field radio communication, information on the operation target device, which is stored in the operation target device connected through the near field radio communication, during the operation,
wherein the information on the operation target device is information: (1) that the operation target device acquires from an external device, and (2) indicates an explanation of operation.
